(19) United States
(12) Patent Application Publication
(10) Pub. No.: US 2023/0191872 A1
(43) Pub. Date: Jun. 22, 2023

(54) Method for Controlling a Heating/Air-Conditioning Component

(71) Applicant: Bayerische Motoren Werke Aktiengesellschaft, Muenchen (DE)

(72) Inventors: Vitali HEIDENREICH, Moosburg (DE); Stefan SOLLINGER, Oberhaching (DE); Maximilian VON LOEWENFELD, Markt Schwaben (DE)

(21) Appl. No.: 18/085,982

(22) Filed: Dec. 21, 2022

(30) Foreign Application Priority Data
Dec. 22, 2021 (DE) 10 2021 134 301.1

(51) Int. Cl. B60H 1/00

(52) U.S. Cl. CPC B60H 1/00735

(57) ABSTRACT

A method controls a heating/air-conditioning component of a hybrid vehicle. In the event of undershooting a minimum state-of-charge of a drive battery, operation of the heating/air-conditioning component is enabled, provided that sufficient electric power is fed to the drive battery such that no further discharging of the drive battery occurs. A hybrid vehicle includes a control device which is appropriate for executing the method.

### CROSS REFERENCE TO RELATED APPLICATION

This application claims priority under 35 U.S.C. § 119 from German Patent Application No. 10 2021 134 301.1, filed Dec. 22, 2021, the entire disclosure of which is herein expressly incorporated by reference.

### BACKGROUND AND SUMMARY

The invention relates to a method for controlling a heating/air-conditioning component, i.e. at least one component for the heating and/or air-conditioning of a hybrid vehicle. The invention further relates to a motor vehicle having a control device which is appropriate for executing the method.

Hybrid vehicles comprise a drive battery which stores and delivers electrical energy, at least for an electric drive system of the hybrid vehicle. In addition to the electric drive system, the drive battery customarily supplies various ancillary loads such as, for example, an electric heater or an electric air-conditioning compressor. It is known that it is not permissible for the drive battery to be fully discharged. This is necessary, firstly for the protection of the drive battery, as complete discharging results in the faster than average ageing of the drive battery. Secondly, considerations of safety require that the drive battery retain a residual charge for the operation of safety-critical vehicle components. Thus, according to the prior art, components which are not safety-critical are customarily deactivated in the event of the undershoot of a minimum state-of-charge of the drive battery. These components include, for example, an air-conditioning compressor of the air-conditioning system. However, this can result in situations, for example, in which a driver climbs into a parked and overheated hybrid vehicle, in which the state-of-charge of the drive battery lies below the minimum state-of-charge and thus, initially, no air-conditioning is available, until such time as the drive battery no longer assumes the critical state-of-charge.

The object of the present invention is therefore the elimination of the above-mentioned disadvantages, at least in in part. This object is fulfilled by a method and a hybrid vehicle according to the independent claims. Advantageous further developments of the invention are the subject matter of the dependent claims.

According to one exemplary embodiment of the invention, a method is provided for controlling a heating/air-conditioning component of a hybrid vehicle wherein, in the event of the undershoot of a minimum state-of-charge of a drive battery, operation of the heating/air-conditioning component is enabled, provided that sufficient electric power is fed to the drive battery such that no further discharging of the drive battery occurs. Operation of the heating/air-conditioning component is otherwise interrupted, or remains interrupted. This exemplary embodiment provides an advantage in that, with the drive battery close to a discharged state, i.e. in the event of the undershoot of the minimum state-of-charge, air-conditioning is available immediately if the combustion engine is running, whilst observing safety standards in force, on the grounds that the vehicle, or the control device thereof, detects that sufficient electrical energy is already being fed to the drive battery, thereby preventing any further discharge of the drive battery. Vehicle passenger comfort can thus be enhanced, as heating and/or air-conditioning can commence forthwith, and it is not necessary to await any overshoot of a minimum state-of-charge.

A hybrid vehicle is a motor vehicle which comprises both a combustion engine and at least one electric motor for the propulsion of the motor vehicle. The heating/air-conditioning component is at least one component for the heating and/or air-conditioning, particularly for the cooling, of a vehicle interior. This can involve one component for heating, one component for air-conditioning (particularly for cooling), one component which executes both functions, or two separate components, one for heating and one for air-conditioning. The minimum state-of-charge refers to a predefined threshold value for the battery charge, in relation to a maximum state-of-charge in kilowatt-hours (kWh).

According to a further exemplary embodiment of the invention, the method controls a heating/air-conditioning component in the form of an air-conditioning compressor. Alternatively or additionally, however, the method can control, for example, an electric interior heater.

According to a further exemplary embodiment of the invention, for such time as the minimum state-of-charge is undershot, the method enables the operation of the heating/air-conditioning component at a reduced capacity only, which is restricted in relation to operation above the minimum state-of charge. For example, for the operation of an air-conditioning compressor, rather than 3.5 kW, only a capacity of 2 kW is made available. Only such capacity is made available to the heating/air-conditioning component as permits meaningful heating/cooling, whilst simultaneously ensuring that there is no breach of a system limit (e.g. a permissible torque of the electric air-conditioning compressor associated with acoustic requirements).

According to a further method, the minimum state-of-charge is lower than 15%, particularly equal to or lower than 10%, of the maximum state-of-charge of the drive battery. The figure of 15% for a minimum state-of-charge refers to an actual state-of-charge, and not to a state-of-charge indicated in the vehicle. Customarily, when the minimum state-of-charge is achieved, a charge of 0% is indicated in vehicles, even though a residual charge is still present in the drive battery; this prevents any confusion of the driver, as the remaining residual charge, in any event, is not fully available for use, as described above in conjunction with the prior art.

According to a further method, electric power is fed to the electric drive battery from an alternator, which is driven by a combustion engine.

The present invention further provides a hybrid vehicle having a computer-implemented control device, which is appropriate for executing one of the above-mentioned methods. For example, a control program which executes such a method is saved in the control device, or in a data memory which is assigned to the control device.

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 is a flowchart illustrating a preferred exemplary embodiment of the present invention.

### DETAILED DESCRIPTION OF THE DRAWING

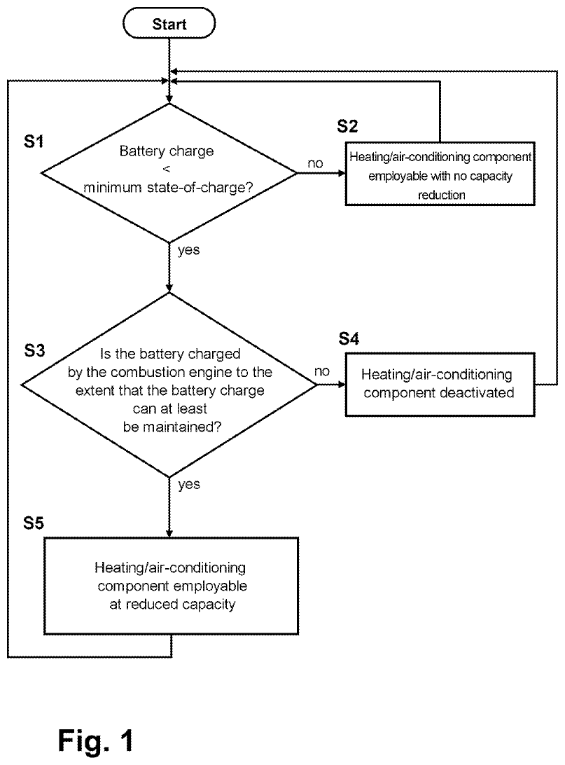

FIG. 1 shows a schematic flow diagram of the method according to the invention, according to an exemplary embodiment of the invention. This method can be implemented, for example, in the form of a computer program, which is saved on a control device or on a data memory which is assigned to the control device. The control device is installed in a hybrid vehicle, i.e. in a motor vehicle, which incorporates both a combustion engine and at least one electric motor for the propulsion of the motor vehicle. The hybrid vehicle moreover has a rechargeable drive battery, which stores electrical energy by an electrochemical method and delivers the latter, at least for the propulsion of the motor vehicle and for at least one heating/air-conditioning component.

The heating/air-conditioning component is particularly an air-conditioning compressor of an air-conditioning system and/or an electric interior heater for the heating of a vehicle interior of the hybrid vehicle.

The method progressively determines whether a battery charge of the drive battery has fallen below a specified minimum state-of-charge (step S1). The minimum state-of-charge refers to the predetermined threshold value for the battery charge, in relation to a maximum state-of-charge, in kilowatt-hours (kWh). This threshold value for the minimum state-of-charge is determined by reference to safety aspects, which define the residual charge which, for reasons of safety (for example, for the supply of safety-critical vehicle components) and for the protection of the drive battery (fully-discharged drive batteries can age more rapidly), is still present and should not be undershot. If this is not the case (“no”), the heating/air-conditioning component is normal, and is employable with no capacity reduction (step S2). The control process then returns to step S1. This can be executed in the form of a continuous check, or determined at regular time intervals.

If it proceeds from step S1 that the minimum state-of-charge has been undershot, the control process, by means of measuring sensors, then determines whether the drive battery is already being recharged, and particularly is being recharged by the operation of the combustion engine (step S3). It is also determined whether the drive battery is charged with sufficient energy to permit the operation of the heating/air-conditioning component. In other words, the charge capacity is required to exceed a minimum value, i.e. the charge capacity must at least be of sufficient magnitude for the operation of the heating/air-conditioning component at reduced capacity. If this is not the case (“no”), the control process then proceeds to step S4, and the heating/air-conditioning component is deactivated, or remains deactivated, if it has already been deactivated. This prevents any significant discharging of the drive battery below the minimum level of charge. The safety of the vehicle is thus enhanced, as a residual charge is maintained for safety reasons.

If it proceeds from the query in step S3 that the drive battery has been sufficiently charged to at least permit the maintenance of the state-of-charge, the control process then proceeds to step S5, in which the employment of the heating/air-conditioning component is permitted with a reduced capacity. The term “reduced” relates to a normal state, for example as per step S2. For example, the reduced capacity of the heating/air-conditioning component is no more than 70% of the maximum capacity of this component.

The control process then returns to step S1, such that the control process, in the event of a change such as, for example, a sufficient state-of-charge of the drive battery, or a declining charging current, can react correspondingly.

The present invention thus provides an advantage in that, in the event of a near-discharged battery and with the combustion engine running, it is not necessary for a vehicle occupant to wait until a specific minimum state-of-charge has been exceeded, which might take a number of minutes, but rather the heating/air-conditioning component is available immediately, in the event of a sufficient charging current, thereby enhancing comfort in a substantially cooled or overheated vehicle.

Although the invention has been illustrated and described in detail in the drawing and in the preceding description, this illustration and description are to be understood as exemplary only, and not by way of limitation, and it is not intended to limit the invention to the exemplary embodiment disclosed. The simple fact that particular features are described in various dependent claims does not signify that an advantageous exploitation of a combination of these features is excluded.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling a heating/air-conditioning component of a hybrid vehicle, comprising:
in an event of undershooting a minimum state-of-charge of a drive battery, enabling operation of the heating/air-conditioning component, provided that sufficient electric power is fed to the drive battery such that no further discharging of the drive battery occurs.

2. The method according to claim 1, further comprising:
controlling a heating/air-conditioning component in the form of an air-conditioning compressor.

3. The method according to claim 1, wherein
for such time as the minimum state-of-charge is undershot, enabling the operation of the heating/air-conditioning component at a reduced capacity only, which reduced capacity is restricted in relation to operation above the minimum state-of charge.

4. The method according to claim 3, wherein
the minimum state-of-charge is lower than 15% of a maximum state-of-charge of the drive battery.

5. The method according to claim 1, wherein
electric power is fed to the electric drive battery from an alternator, which is driven by a combustion engine.

6. A hybrid vehicle comprising a control device operatively configured to enable operation of a heating/air-conditioning component in an event of undershooting a minimum state-of-charge of a drive battery, provided that sufficient electric power is fed to the drive battery such that no further discharging of the drive battery occurs.

7. The hybrid vehicle according to claim 6, wherein
the heating/air-conditioning component is an air-conditioning compressor.

8. The hybrid vehicle according to claim 6, wherein
for such time as the minimum state-of-charge is undershot, the control device enables the operation of the heating/air-conditioning component at a reduced capacity only, which reduced capacity is restricted in relation to operation above the minimum state-of charge.

9. The hybrid vehicle according to claim 8, wherein
the minimum state-of-charge is lower than 15% of a maximum state-of-charge of the drive battery.

10. The hybrid vehicle according to claim 6, further comprising a combustion engine and an alternator, wherein
electric power is fed to the electric drive battery from the alternator, which is driven by the combustion engine.
